(19) United States
(12) Patent Application Publication
(10) Pub. No.: US 2018/0089822 A1
(43) Pub. Date: Mar. 29, 2018

(54) AUTOMATED DIAGNOSTICS FOR DEVICE DISPLAY AND CAMERA

(71) Applicant: Pervacio Inc., Irving, TX (US)

(72) Inventors: Smita Madhukar Nirmal, Bangalore (IN); Ankit Kumar, Bilaspur (CG) (IN); Satyanarayana Chidurala, Bangalore (IN); Kumar Shree Mohanty, Jatni (IN); Dinkar Raj, Muvattupuzha (IN); Debashish Sahoo, Naupada (IN); Ganesh Jayadevan, Bangalore (IN)

(21) Appl. No.: 15/706,381

(22) Filed: Sep. 15, 2017

Related U.S. Application Data
(60) Provisional application No. 62/395,111, filed on Sep. 15, 2016.

(51) Int. Cl. G06T 7/00; G02B 17/00; G02B 27/00; G02B 17/06

(52) U.S. Cl. CPC G06T 7/0004; G02B 17/008; G06T 2207/30164; G02B 17/06; G02B 27/0018

(57) ABSTRACT

A system for diagnosing problems experienced with a mobile device includes a processor and first, second, third and fourth mirrors arranged such that light travels from a mobile device display to strike each of the first, second, third and fourth mirrors in turn and is reflected into a camera of the mobile device. The processor is configured to analyze the light received by the camera of the mobile device to diagnose problems experienced with the camera, the mobile device display or both.

### SUMMARY

It is an object of the disclosure to describe a method for diagnosing mobile device malfunction which includes placing a mobile device in a test jig having first, second, third and fourth mirrors; presenting an image to a display of the mobile device such that light comprising the image travels from the display to at least one of the first, second, third and fourth mirrors, is reflected and is then received by a camera of the mobile device; and with a processor, analyzing the light received by the camera in order to diagnose malfunction of the display or the camera.

It is another object of the disclosure to describe a method for providing a mobile device test system including assembling a test jig with a harness configured to support a test mobile device; arranging first, second, third and fourth mirrors inside the test jig such that light emitted from a display of a test mobile device supported by the harness travels from the display to at least one of the first, second, third and fourth mirrors, is reflected and is then received by a camera of the mobile device; and installing, to a processor operatively coupled with the test mobile device, a tool configured to analyze the light emitted from the display of the test mobile device to diagnose malfunction of the camera, the display or both.

It is yet another object of the disclosure to describe a system for diagnosing problems experienced with a mobile device which includes a test jig with a harness configured to support a test mobile device; first, second, third and fourth mirrors arranged such that light travels from a display of a test mobile device supported by the harness to strike each of the first, second, third and fourth mirrors in turn and is reflected into a camera of the test mobile device; and a processor configured to analyze the light received by the camera of the test mobile device to diagnose problems experienced with the camera, the display or both.

### BRIEF DESCRIPTION OF THE FIGURES

The following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those of ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic sectional view of an example test jig for use in disclosed systems for diagnosing problems experienced with a mobile device.

FIG. 2 illustrates a perspective view of an example test jig for use in disclosed systems for diagnosing problems experienced with a mobile device.

FIG. 3 illustrates a schematic of an example subject mobile device on which diagnosis is to be performed.

FIG. 4 illustrates a flow diagram of an example method for diagnosing problems experienced with a mobile device.

FIG. 5 illustrates a schematic of another example test jig for use in disclosed systems for diagnosing problems experienced with a mobile device.

FIG. 6 illustrates an example test mobile device in a first position in an example test jig having an example card system used to derive camera quality.

FIG. 7 illustrates an example test mobile device in a second position in an example test jig having an example card system used to derive camera quality.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced items.

Embodiments of the present disclosure substantially eliminate, or at least partially address, problems in the prior art, enabling more effective diagnosis of mobile device displays, mobile device cameras or both so as to reduce dependence on human skill for evaluating the operation of a mobile device. Embodiments further provide systems and methods for performing diagnoses at a low complexity and low cost while requiring limited or reduced physical space.

Additional aspects, advantages, features and objects of the present disclosure will be made apparent from the drawings and the detailed description of the illustrative embodiments construed in conjunction with the appended claims that follow. For example, automatic, standardized test processes eliminate conflicts of interest in reverse logistics personnel who are incentivized to sell new devices rather than recondition old devices.

It will be appreciated that features of the present disclosure are susceptible to being combined in various combinations without departing from the scope of the present disclosure as defined by the appended claims.

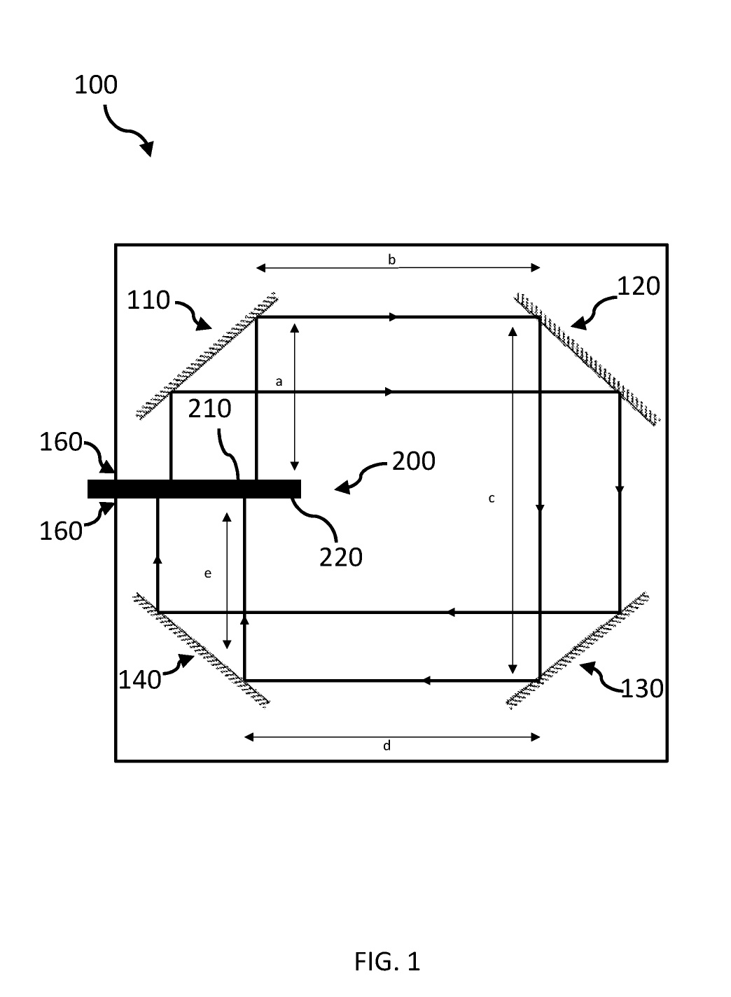

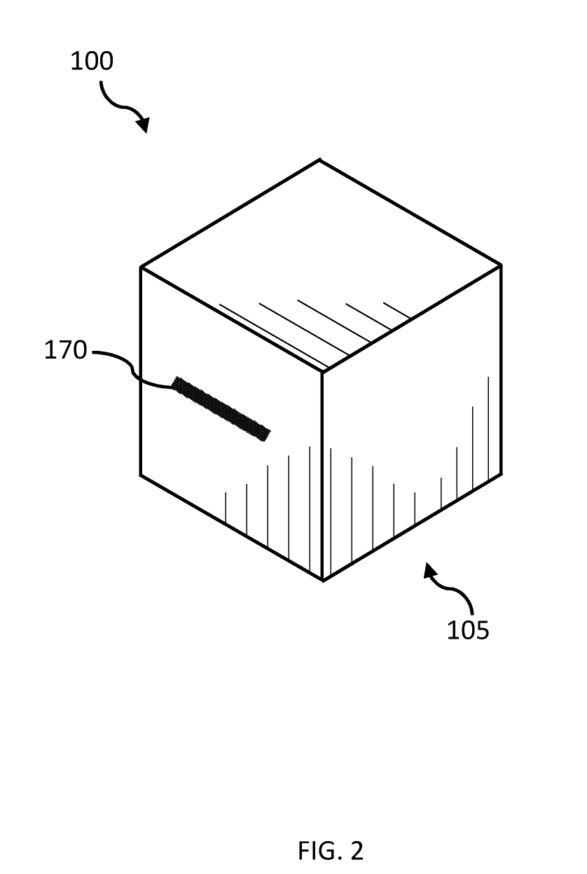

Referring to FIGS. 1 & 2, a system 100 for diagnosing problems experienced with a mobile device includes a test jig 105 (FIG. 2) which may function as a dark box preventing any external light from penetrating its interior. Test jig 105 includes first 110, second 120, third 130 and fourth 140 mirrors arranged such that light (for example, light forming an image on the mobile device display) travels from the mobile device display 210 to strike each of the first 110, second 120, third 130 and fourth 140 mirrors sequentially and is reflected into a camera of mobile device 200. For example, light travels from the mobile device display 219 to the first mirror 110, from the first mirror 110 to the second mirror 120, from the second mirror 120 to the third mirror 130, from the third mirror 130 to the fourth mirror 140 and from the fourth mirror 140 to the camera 210. In another example, light may be reflected from the first mirror directly into the camera.

In an example, the second mirror 120 is oriented at 90 degrees relative to the first mirror 110 and the third mirror 130 while being parallel to the fourth mirror 140. The arrangement of first 110, second 120, third 130 and fourth 140 mirrors are further configured to avoid causing ghost images or multiple reflections to be received by the mobile device camera 220. In an example, the mirrors comprise first surface or front surface mirrors which lack a transparent substrate in front of their reflective surface.

Test jig 105 includes a slot 170 for receiving at least a portion of a test mobile device and a support 160, which may be a harness, is configured to orient the mobile device display at a 45 degree angle to each of the first, second, third and fourth mirrors. In an example, the support may clamp or grip the mobile device at the point of insertion of the mobile device into the diagnostics system.

The distance travelled by the light between the mobile device display and the mobile device camera is sufficient to overcome accentuation of rainbow-like colors captured by the mobile device camera and also sufficient to overcome Moire effect, rainbow effect, refresh lines, and fixed pattern noise.

In an example, the distance travelled is 32 cm or longer. In an example arrangement, the distance between the center of the first mirror and the center of the second mirror is less than 32 cm, the distance between the center of the second mirror and the center of the third mirror is less than 32 cm, the distance between the center of the third mirror and the center of the fourth mirror is less than 32 cm and the distance between the center of the first mirror and the center of the fourth mirror is less than 32 cm.

In another example, the distance travelled by the light is 50 cm or longer. In another example arrangement, the distance between the center of the first mirror and the center of the second mirror is less than 50 cm, the distance between the center of the second mirror and the center of the third mirror is less than 50 cm, the distance between the center of the third mirror and the center of the fourth mirror is less than 50 cm and the distance between the center of the first mirror and the center of the fourth mirror is less than 50 cm.

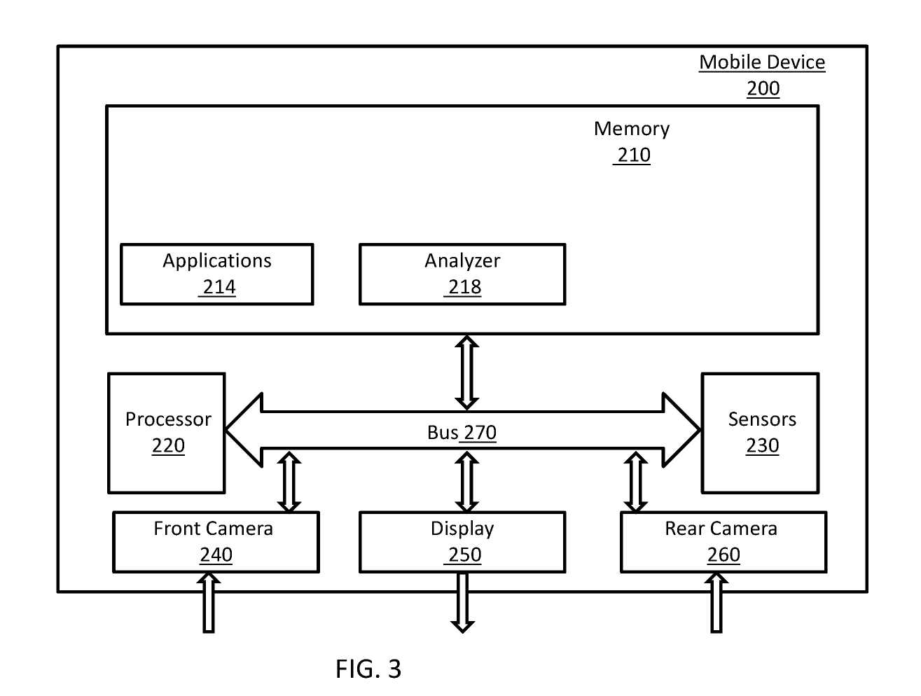

FIG. 3 depicts a schematic of an example mobile device for which the disclosed system may be used to diagnose problems. A mobile device 200 configured for use with systems and methods of the disclosure, may include but is not limited to a memory 210, a processor 220, sensors 230, a display 250, one or more front cameras 240, one or more rear cameras 260, and a bus 270 configured to operatively couple memory 210, processor 220, sensors 230, display 250, front camera 240 and the rear camera 260.

Mobile device 200 may also include a power source for supplying electrical power to the various components. The power source, for example, may include a rechargeable battery or may receive power from an outside source as by converting alternating current from a residential or industrial wall outlet to direct current.

Mobile device memory 210 optionally includes non-removable memory, removable memory, or a combination thereof. The non-removable memory, for example, includes Random-Access Memory (RAM), Read-Only Memory (ROM), flash memory, or a hard drive. The removable memory, for example, may include flash memory cards, memory sticks, or smart cards.

Referring to FIG. 3, mobile device memory 210 or other memory of mobile device 200 may store an analyzer module 218 as well as applications 214. Analyzer module 218 may, for example, be part of a software product associated with the mobile device service.

Executing the software product on mobile device processor 220 (FIG. 3), for example as interpreted by an operating system, results in presenting an image to a display 250 of the test mobile device and analyzing the light received by the camera to diagnose malfunction of the display or the camera. Generating and rendering a graphical user interface to display 250 may be managed by a display manager of analyzer module 218 while analytics and other data may be managed by a data manager of the analyzer module. Control of one or more components of mobile device 200 needed for the mobile device service, such as cameras 250/260 and display 250 is handled with a control manager of the analyzer module.

In some examples, mobile device display 250 (FIG. 3) may be a touch-sensitive display screen that is operable to receive tactile inputs from the user. These tactile inputs may, for example, include clicking, tapping, pointing, moving, pressing and/or swiping with a finger or a touch-sensitive object like a pen.

Mobile device 200 may also include I/O devices in addition to display 250 and cameras 240 and 260 such as a physical or virtual mouse or a physical or virtual joystick operable to receive inputs corresponding to clicking, pointing, and/or moving a pointer object on the graphical user interface. Additionally, mobile device I/O devices may also include a microphone for receiving an audio input from the user, and a speaker for providing an audio output to the user.

Moreover, mobile device sensors 230 may include one or more of: a multimeter, an accelerometer, a magnetometer, a pressure sensor, a temperature sensor, a gyroscopic sensor, a Global Positioning System (GPS) sensor, or a timer which may be used to measure and collect data related to performance of the mobile device and surroundings of the mobile device. Additionally, outputs generated by sensors 230 may, for example, be indicative of mobile device analytics data. A timer included as part of sensors 230 may, for example, enable inclusion of time-stamps with display/camera analytics data.

In some examples, analyzer module 218 may be interfaced with mobile device sensors 230 such that when executed on mobile device processor 220, analyzer module 218 is configured to resolve and integrate outputs of sensors 230 into useful information about, for example, mobile device display and/or camera performance.

Further, the disclosed mobile device 200 as well as the configuration of memory 210 as depicted in FIG. 3 are merely examples, which should not unduly limit the scope of the claims. It is to be understood that the specific designation for mobile device 200, memory 210 and analyzer module 218 are provided as examples and are not to be construed as limiting mobile device 200, memory 210 or analyzer module 218 to specific numbers, types, or arrangements of modules and/or components. A person skilled in the art will recognize many variations, alternatives, and modifications of embodiments of the present disclosure. Mobile device 200 is optionally implemented by way of at least one of: a mobile phone, a smart telephone, an MID, a tablet computer, a UMPC, a phablet computer, a PDA, a web pad, a handheld PC, a laptop computer, and an interactive entertainment device.

In accordance with analyzer module 218 installed to memory 210, a processor 220 is configured to analyze the light received by the camera of mobile device 200 to diagnose problems experienced with the camera, mobile device display 250 or both. Analysis by processor 220 is further configured to diagnose blur, spots, color shifting, light leak, Lomo effect, cracked lens, scratched lens, water inside lens, cracked display, pixelated display flickering display, contrast issues, display ghosts or any combination of these. In an example, a processor used to analyze test data is not a component of the mobile device being tested. In an example, the camera is a first camera or a front camera.

The system may be further configured to cause light being emitted from display 250 of mobile device 200 to be received by a second camera of the mobile device. In an example, the second camera of the mobile device is provided to a rear side of mobile device 200 opposite that to which the first (front) camera is provided. Processor 220, for example in accordance with analyzer module 218, is further configured to analyze the light received by rear camera 260 of mobile device 200 to diagnose problems experienced with rear camera 260, display 250 and/or front camera 240.

In some examples, analyzer module 218 may be stored and executed by a computing device remote to but operatively coupled to the subject mobile device being diagnosed. For example, information recorded by one or more cameras of the test mobile device may be transmitted to the remote computing device wirelessly or by a wired connection.

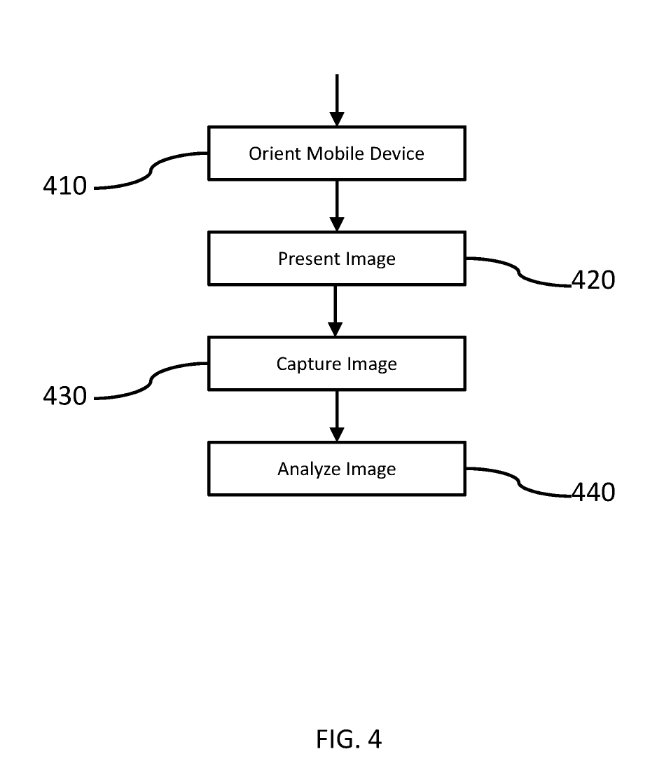

FIG. 4 illustrates actions of a method for diagnosing problems experienced with a mobile device, in accordance with an embodiment of the present disclosure. The method is depicted as a collection of actions in a logical flow diagram, which represents a sequence of actions at least some of which may be implemented in hardware, software, or a combination thereof.

A method for diagnosing problems experienced with a mobile device includes orienting a mobile device at 410, presenting an image to a mobile device display at 420 such that light travels from the display to strike each of first, second, third and fourth mirrors in turn and is reflected into a camera of the mobile device, capturing the image of the mobile device display at 430 and analyzing the image captured by the camera of the mobile device at 440 to diagnose problems experienced with the camera, the mobile device display or both.

The mobile device may be oriented, for example, such that the mobile device display is oriented at a 45 degree angle to the first mirror and the camera is directed at a 45 degree angle to the fourth mirror. In another example, the mobile device is oriented such that the mobile device display is oriented at a 45 degree angle to the first mirror and the camera is directed in a direction opposite that of the display.

In yet another example, the mobile device is oriented such that the mobile device display is oriented at a 45 degree angle to the first mirror and a mobile device camera is directed in the same direction as the display. In this example, the mobile device camera may be a second, forward-facing camera. Light received by the second camera of the mobile device may be analyzed to diagnose problems experienced with the second camera.

The method may further include arranging the mirrors such that a distance travelled by the light is sufficient to overcome accentuation of rainbow-like colors appearing on a display when captured by the mobile device camera and such that a distance travelled by the light is sufficient to overcome Moire effect, rainbow effect, refresh lines, and fixed pattern noise.

In an example, arranging the mirrors may require a distance travelled by the light be 32 cm or longer. In a further example, arranging the mirrors may result in a distance between the center of the first mirror and the center of the second mirror be less than 32 cm, a distance between the center of the second mirror and the center of the third mirror be less than 32 cm, a distance between the center of the third mirror and the center of the fourth mirror be less than 32 cm and/or a distance between the center of the first mirror and the center of the fourth mirror be less than 32 cm.

In another example, arranging the mirrors may require a distance travelled by the light be 50 cm or longer. In a further example, arranging the mirrors may result in a distance between the center of the first mirror and the center of the second mirror be less than 50 cm, a distance between the center of the second mirror and the center of the third mirror be less than 50 cm, a distance between the center of the third mirror and the center of the fourth mirror is less than 50 cm and/or a distance between the center of the first mirror and the center of the fourth mirror be less than 50 cm.

The method avoids causing ghost images or multiple images being received by the mobile device camera. For example, arranging the first, second, third and fourth mirrors, includes, arranging the mirrors as first surface mirrors.

The light received by the camera may be analyzed to diagnose blur, spots, color shifting, light leak in a camera, Lomo effect in a camera, cracked lens, scratched lens, water inside lens, cracked display, pixelated display flickering display, contrast issues, ghosts or any combination of these.

The actions depicted are only illustrative and other alternatives can also be provided where one or more actions are added, one or more actions are removed, or one or more actions are provided in a different sequence without departing from the scope of the claims herein.

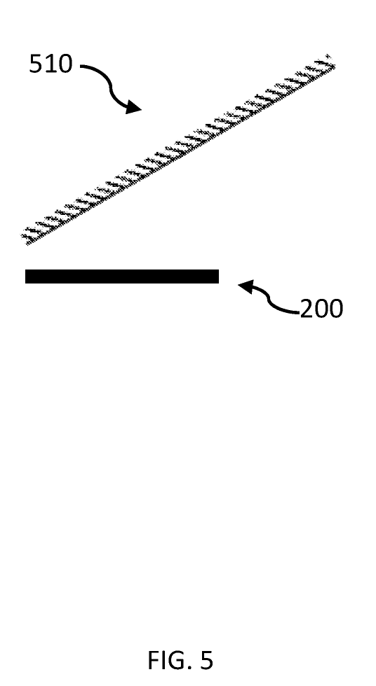

FIG. 5 illustrates a schematic of another example test jig for use in disclosed systems for diagnosing problems experienced with a mobile device. A front facing camera of a test device takes an image of a display of the test device using the nearest mirror 510. Mirror 510 and test device 200 need not be parallel and a small angle may exist in between while still allowing the camera to capture an image of the display in the example four-mirror jig described above. In this arrangement, disambiguation of faults is improved so that issues with a display can be distinguished from issues with a camera.

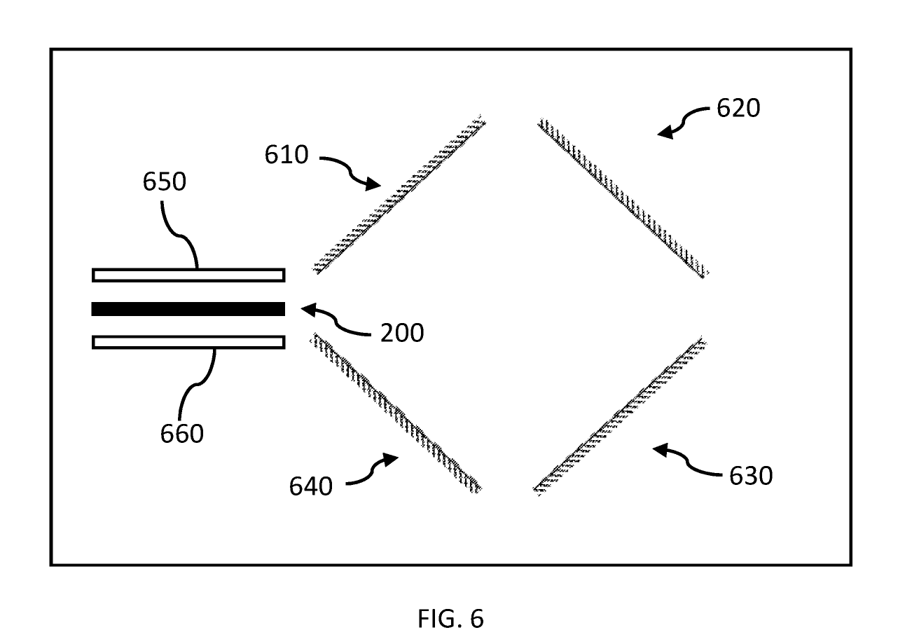

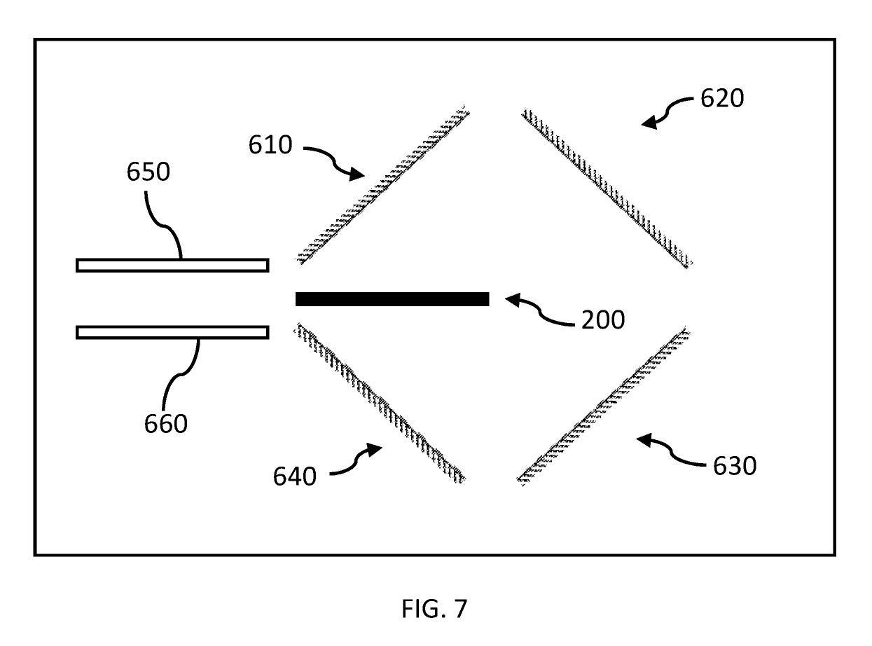

FIGS. 6 & 7 illustrate an example sub-jig 650 and 660 used inside an example test jig and configured to derive a camera quality measurement. A pair of test cards 650 and 660 are provided adjacent to the arrangement of mirrors such that, when in a first position (FIG. 6), the camera of test mobile device 200 captures an image of the test cards 650 and 660 and, when in a second position (FIG. 7), may capture images of its own display. Test cards 650 and 660 may be black, white or colored depending on the qualities being tested. After testing at the first position (FIG. 6), the quality of the one or more cameras of the test device is known for application to the testing applied at the second position (FIG. 7). For example, if it is determined while the test device is in the first position that a first camera is operating at a high fidelity while a second camera is operating at a reduced fidelity, the first camera may be preferred for testing to be performed with the test device at the second position.

Embodiments of the present disclosure may provide analyzer 218 as a computer program product that includes a non-transitory or non-transient computer-readable storage medium storing computer-executable code for diagnosing problems experienced with a mobile device. The code, when executed, is configured to perform actions of disclosed example analytical methods performed by a processor or other computing device as described in conjunction with FIG. 4. The code may be executed by a component processor of the mobile device, a processor of an independent computing device, or a combination of these. In some examples, the code may be downloaded from a software application store, for example, from an “App store”, to a data processing unit.

As actions of the disclosed methods may be provided in different sequences, so the computer-executable code may be configured to provide a service having a different sequence of actions from those disclosed.

Embodiments of the present disclosure are susceptible to being used for various purposes, including, though not limited to, diagnosis of problems experienced with one or more mobile devices according to standardized test processes.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for diagnosing mobile device malfunction, comprising:
placing a mobile device in a test jig having first, second, third and fourth mirrors;
presenting an image to a display of the mobile device such that light of which the image is comprised travels from the display to at least one of the first, second, third and fourth mirrors, is reflected and then received by a camera of the mobile device; and
with a processor, analyzing the light received by the camera to diagnose malfunction of the display or the camera.

2. The method as set forth in claim 1, wherein presenting the image to the display of the mobile device further comprises presenting the image such that light of which the image is comprised travels from the display to the first mirror, is reflected by the first mirror and then received by the camera of the mobile device.

3. The method as set forth in claim 1, wherein placing the mobile device further comprises orienting the mobile device such that the display forms a 45 degree angle with the first mirror and the camera is directed at a 45 degree angle to the first mirror.

4. The method as set forth in claim 1, wherein presenting the image to the display of the mobile device further comprises presenting the image such that light of which the image is comprised travels from the display to the first, second, third and fourth mirrors, sequentially, and is received by the camera.

5. The method as set forth in claim 1, wherein placing the mobile device further comprises placing the mobile device such that a distance travelled by the light is sufficient to overcome accentuation of rainbow-like colors appearing on the display as captured by the camera.

6. The method as set forth in claim 1, wherein placing the mobile device further comprises preventing receipt of ghost images or multiple images by the camera.

7. The method as set forth in claim 1, wherein analyzing the light further comprises diagnosing blur, spots, color shifting, light leak from the camera, Lomo effect from the camera, cracked lens, scratched lens, water inside lens, cracked display, pixelated display, flickering display, contrast issues, ghost images or any combination of these.

8. A method for providing a mobile device test system, comprising:
assembling a test jig with a harness configured to support a test mobile device;
arranging first, second, third and fourth mirrors inside the test jig such that light emitted from a display of a test mobile device supported by the harness travels from the display to at least one of the first, second, third and fourth mirrors, is reflected and then received by a camera of the mobile device; and
installing, to a processor operatively coupled with the test mobile device, a tool configured to analyze the light emitted from the display of the test mobile device to diagnose malfunction of the camera, the display or both.

9. The method as set forth in claim 8, wherein arranging the first, second, third and fourth mirrors further comprises arranging the first mirror such light emitted from a display of a test mobile device supported by the harness travels from the display to the first mirror, is reflected and then received by the camera of the mobile device.

10. The method as set forth in claim 8, wherein assembling the test jig with the harness configured to support a test mobile device further comprises configuring the harness to support a test mobile device such that a display and a camera of the test mobile device are oriented at a 45 degree angle to the first mirror.

11. The method as set forth in claim 8, wherein arranging the first, second, third and fourth mirrors further comprises arranging the first mirror such light emitted from a display of a test mobile device supported by the harness travels from the display to the first, second, third and fourth mirrors, in turn, and is received by the camera of the mobile device.

12. The method as set forth in claim 8, wherein arranging the first, second, third and fourth mirrors further comprises arranging the first, second, third and fourth mirrors such that a distance traveled by light emitted from a display of the test mobile device is sufficient to overcome accentuation of rainbow-like colors appearing on the display as captured by the camera.

13. The method as set forth in claim 8, wherein assembling the test jig with the harness configured to support a test mobile device further comprises configuring the harness to support a test mobile device such that receipt of ghost images or multiple images by the camera is avoided.

14. The method as set forth in claim 8, wherein arranging the first, second, third and fourth mirrors further comprises arranging first, second, third and fourth first-surface mirrors.

15. A system for diagnosing problems experienced with a mobile device, comprising:
a test jig with a harness configured to support a test mobile device;
first, second, third and fourth mirrors arranged such that light travels from a display of a test mobile device supported by the harness to strike at least one of the first, second, third and fourth mirrors and is reflected into a camera of the test mobile device; and
a processor configured to analyze the light received by the camera of the test mobile device to diagnose problems experienced with the camera, the display or both.

16. The system as set forth in claim 15, wherein the first mirror is arranged such that light emitted from a display of a test mobile device supported by the harness travels from the display to the first mirror, is reflected and then received by the camera of the mobile device.

17. The system as set forth in claim 15, wherein the harness is configured to support a test mobile device such that a display and a camera of the test mobile device are oriented at a 45 degree angle to the first mirror.

18. The system as set forth in claim 15, wherein the first mirror is arranged such that light emitted from a display of a test mobile device supported by the harness travels from the display to the first, second, third and fourth mirrors, in turn, and is received by the camera of the mobile device.

19. The system as set forth in claim 15, wherein the first, second, third and fourth mirrors are arranged such that a distance traveled by light emitted from a display of a test mobile device supported by the harness is sufficient to overcome accentuation of rainbow-like colors appearing on the display as captured by the camera.

20. The system as set forth in claim 15, wherein the harness is configured to support a test mobile device such that receipt of ghost images or multiple images by a camera of the test mobile device is avoided.

21. The system as set forth in claim 15, wherein the first, second, third and fourth mirrors are arranged as first surface mirrors.

22. A system for diagnosing problems experienced with a mobile device, comprising:
first, second, third and fourth mirrors arranged such that light travels from a mobile device display to strike each of the first, second, third and fourth mirrors in turn and is reflected into a camera of the mobile device; and
a processor configured to analyze the light received by the camera of the mobile device and diagnose problems experienced with the camera, the mobile device display or both.
